(19) United States
(12) Patent Application Publication
(10) Pub. No.: US 2005/0254700 A1
(43) Pub. Date: Nov. 17, 2005

(54) Apparatus and method for detecting hole area

(75) Inventors: Yasushi Nagata, Kyoto (JP); Hiroshi Sano, Kyoto (JP); Atsushi Imamura, Kyoto (JP); Eiji Nishihara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/102,770

(22) Filed: Apr. 11, 2005

(30) Foreign Application Priority Data
May 13, 2004 (JP) P2004-143798

(51) Int. Cl. G06K 9/00

(52) U.S. Cl. 382/149

(57) ABSTRACT

A board (9) is placed on a stage part (20) so that the back surface of the board is opposed to the stage part (20). The stage part cuts off light entering a hole penetrating the board (9) from a side of its back surface which is a reverse surface with respect to its pattern formed surface and has a reflection property which is different from that of the pattern formed surface with respect to an illumination light, and the illumination light is emitted from a light source part (31) onto the pattern formed surface (9a). An image pickup part (33) receives light from the pattern formed surface to acquire an inspection image, and a hole-area specifying part implemented by a computer (4) specifies a hole area in the inspection image, which corresponds to a hole of the board (9), by using only the inspection image as image information, in accordance with criteria of pixel values affected by a reflection state of the illumination light entering a hole penetrating the board (9) and being reflected on the stage part (20). Thus, it is possible to detect an area of a hole on the board (9) by using only the inspection image acquired with a reflected light of the illumination light from the light source part (31).

### BACKGROUND OF THE INVENTION

1. Field of the Invention

The present invention relates to a technique for detecting an area of a hole penetrating a board.

2. Description of the Background Art

In inspection of a printed circuit board (hereinafter, referred to as “board”), conventionally, detection of through holes for wiring which are formed on the board is performed. For example, Japanese Patent Application Laid Open Gazette No. 6-288739 (Document 1) discloses a technique where an image pickup part is provided for picking up an image of a main surface (front surface) of a board where a pattern is formed, and an illumination light is emitted onto the front surface of the board and light is also emitted from a side of back surface of the board, to detect an area in an image acquired by the image pickup part, which corresponds to a through hole. Japanese Patent Application Laid Open Gazette No. 5-196435 (Document 2) suggests a technique where a fluorescent material is provided, being opposed to a back surface of a board, and an illumination light is emitted onto a fluorescent front surface of the board to pick up an image, to thereby detect a through hole while acquiring an image of pattern on the board on the basis of fluorescence from the front surface of the board and that from the fluorescent material which is guided through the through hole.

Japanese Patent Application Laid Open Gazette No. 2002-259967 (Document 3) discloses a technique where in a predetermined color space, angle indices in accordance with angles between individual color vectors representing colors of pixels in a color image to be divided and respective representative color vectors of a plurality of representative colors which are set and distance indices in accordance with distances between the colors of the pixels in the image and the respective representative colors are obtained, and the pixels in the image are grouped into a plurality of representative colors in accordance with composite distance indices based on the angle indices and the distance indices, to divide the color image. A relocation method (K-mean method) is also well known, where a plurality of provisional representative colors corresponding to a plurality of areas in an image are set, a color space is divided so that each of the pixels arranged in the color space should be included in the divided space corresponding to one of a plurality of representative colors which is closest to the pixel, an average value of colors of all the pixels included in the divided space of each representative color is determined as a new representative color, and the above operation is repeated to divide the image into a plurality of areas (see “Description of the Background Art” in Japanese Patent Application Laid Open Gazette No. 11-316193 (Document 4)).

Japanese Patent Application Laid Open Gazette No. 5-6421 (Document 5) discloses a method where a plurality of membership functions corresponding to a plurality of geometric feature values for each model pattern element are prepared and an adaptation degree for each model pattern element is obtained by using the membership functions, from a plurality of geometric feature values calculated for each of a plurality of areas in a binary object image, to obtain the model pattern element to which each area belongs to by comparing a plurality of adaptation degrees.

In the method of Patent Document 1, however, it is necessary to provide another light source part for emitting light from the side of back surface besides the light source part for emitting the illumination light with which the front surface of the board is irradiated, and this disadvantageously causes upsizing of an apparatus. In the method of Document 2, a special fluorescent board is needed and a fluorescent material which generates fluorescence having almost the same wavelength as that of the board is also needed, and therefore the kinds of board on which detection of through holes is possible are limited.

### SUMMARY OF THE INVENTION

It is an object of the present invention to detect an area of a hole in a board by using only an illumination light with which a front surface of the board is irradiated.

The present invention is intended for an apparatus for detecting an area of a hole penetrating a board. The apparatus comprises a light source part for emitting an illumination light onto one main surface of a board, an opposed member provided, being opposed to the other main surface of the board, to cut off light entering a hole penetrating the board from a side of the other main surface, having a reflection property which is different from that of the one main surface with respect to the illumination light, an image pickup part receiving light from the one main surface onto which the illumination light is emitted to acquire an image representing the one main surface, and a hole-area specifying part for specifying a hole area in the image, which corresponds to a hole penetrating the board, by using only the image as image information, in accordance with criteria of pixel values affected by a reflection state of the illumination light entering a hole penetrating the board and being reflected on the opposed member.

Since the reflection property of the opposed member is different from that of one main surface of the board, it is possible to detect the area of the hole in the board by using only the image acquired with a reflected light of the illumination light from the light source part as image information.

According to an aspect of the present invention, in the apparatus, the light source part emits an illumination light of a plurality of wavelengths and the image pickup part acquires a multicolor image, and the opposed member comprises an opposed surface being in contact with the other main surface, having such spectral reflectance as to make spectral intensity of a reflected light thereon different from that of a reflected light on the one main surface with respect to the illumination light. It is thereby possible to specify the hole area with high accuracy.

According to another aspect of the present invention, the opposed member comprises an opposed surface being in contact with the other main surface, having reflectance which is higher than that of the one main surface with respect to the illumination light. Preferably, the opposed surface is a mirror.

According to still another aspect of the present invention, the opposed member absorbs the illumination light more than the one main surface, and preferably, the opposed member comprises a recessed portion opposed to the board, having an inside surface of black.

The present invention is suitable to detect a hole area with respect to a printed circuit board on which a through hole for wiring is formed. In this case, preferably, the apparatus further comprises a through-hole specifying part for specifying whether the hole area specified by the hole-area specifying part corresponds to the through hole for wiring or not, on the basis of shape or number of pixels (i.e., area) of the hole area.

The present invention is also intended for a method of detecting an area of a hole penetrating a board.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing a construction of a defect detection apparatus in accordance with a first preferred embodiment;

FIG. 2 is a block diagram showing a functional structure of a computer;

FIG. 3 is a flowchart showing an operation flow for detecting a defect on a board;

FIG. 4 is a view showing the board placed on a stage part;

FIG. 5 is a view illustrating part of a pattern formed surface of the board;

FIG. 6 is a schematic view showing the board placed on the stage part;

FIG. 7 is a view showing an inspection image;

FIG. 8 is a view showing a hole-area detection image;

FIG. 9 is a view showing a through-hole detection image;

FIG. 10 is a view showing another exemplary construction of a defect detection apparatus in accordance with a second preferred embodiment; and

FIG. 11 is a view showing a stage part of a defect detection apparatus in accordance with a third preferred embodiment.

### DESCRIPTION OF THE PREFERRED EMBODIMENTS

FIG. 1 is a view showing a construction of a defect detection apparatus 1 in accordance with the first preferred embodiment of the present invention. The defect detection apparatus 1 comprises a stage part 20 for holding a board 9 which is a printed circuit board, on which a wiring pattern is formed, an image pickup unit 3 for picking up an image of the board 9 to acquire a color inspection image, a stage driving part 21 for moving the stage part 20 relatively to the image pickup unit 3, and a computer 4 constituted of a CPU for performing various computations, a memory for storing various pieces of information and the like. The computer 4 serves as a control part for controlling these constituent elements in the defect detection apparatus 1.

The image pickup unit 3 has a light source part 31 having, e.g., a mercury vapor lamp, for emitting a white illumination light, an optical system 32 for guiding the illumination light to the board 9 and receiving light from the board 9 and an image pickup part 33 in which photodetectors are two-dimensionally arrayed. The image pickup unit 3 makes an incident-light illumination where the illumination light is emitted by the optical system 32 from a direction almost orthogonal to the board 9, and the image pickup part 33 converts an image of the board 9 formed by the optical system 32 into an electrical signal and outputs data of the inspection image. The stage driving part 21 has an X-direction moving mechanism 22 for moving the stage part 20 in the X direction of FIG. 1 and a Y-direction moving mechanism 23 for moving the stage part 20 in the Y direction. The X-direction moving mechanism 22 has a motor 221 to which a ball screw (not shown) is connected and with rotation of the motor 221, the Y-direction moving mechanism 23 moves along guide rails 222 in the X direction of FIG. 1. The Y-direction moving mechanism 23 has the same structure as the X-direction moving mechanism 22 has, and with rotation of a motor 231, the stage part 20 is moved along guide rails 232 in the Y direction of FIG. 1 by a ball screw (not shown).

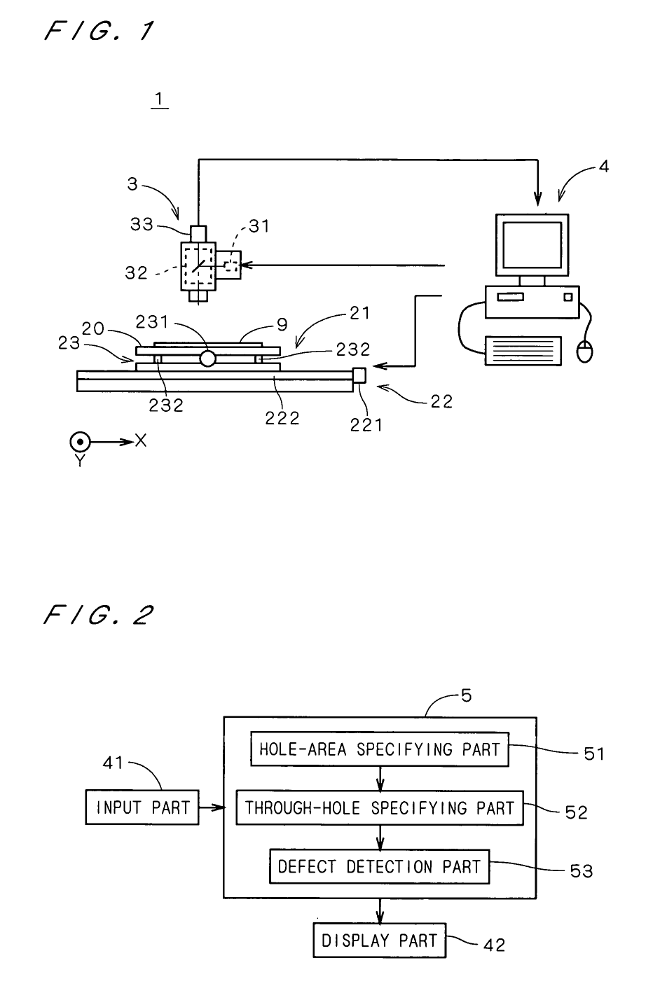

FIG. 2 is a block diagram showing a functional structure implemented by the CPU, the memory and the like of the computer 4. This figure shows functions of constituent elements of an operation part 5 implemented by the CPU and the like. These functions of the operation part 5 may be implemented by dedicated electric circuits, or may be partially implemented by the dedicated electric circuits.

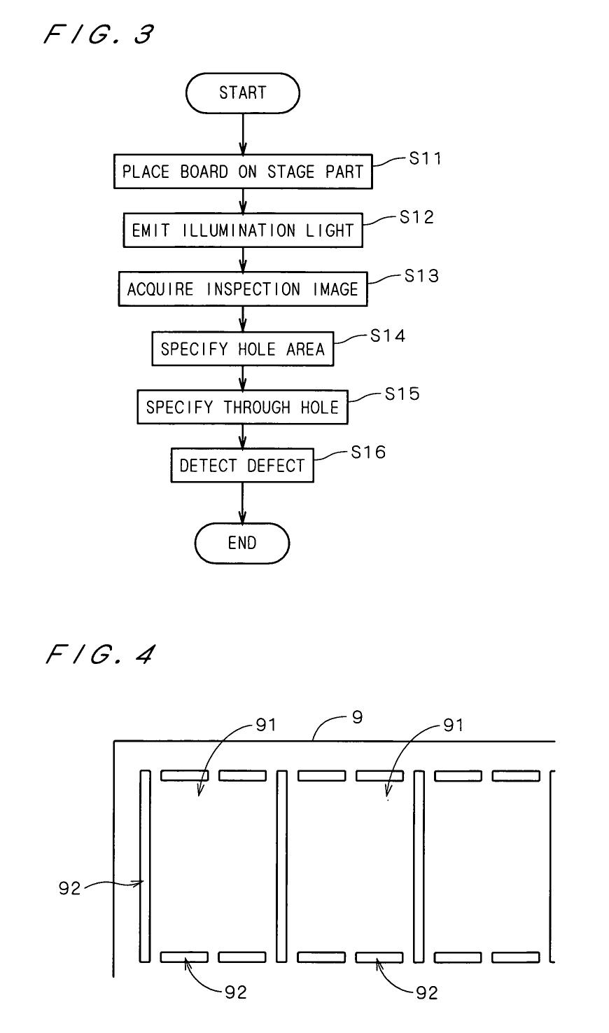

FIG. 3 is a flowchart showing an operation flow of the defect detection apparatus 1 for detecting a defect on the board 9. In the defect detection apparatus 1, first, the target board 9 is placed on the stage part 20 with its main surface on which a pattern is formed (hereinafter, referred to as “pattern formed surface”) facing the image pickup unit 3 (Step S11). In the board 9, however, a pattern may be formed also on the other main surface which is a reverse surface with respect to the pattern formed surface (hereinafter, referred to as “back surface”).

FIG. 4 is a view showing the board 9 placed on the stage part 20. As shown in FIG. 4, in the board 9, a plurality of divided areas 91 on which a plurality of independent wiring blocks are formed, respectively, are arrayed and holes 92 penetrating the board 9 are formed around each of the divided areas 91. The divided areas 91 of the board 9 are separated from the board 9 after manufacturing of the board 9 and mounting of electronic devices, and one of the divided areas 91 is provided to one of various electronic equipments as one circuit board. In the following discussion, the hole 92 is referred to as “auxiliary hole 92”.

FIG. 5 is a view illustrating part of the pattern formed surface of the board 9. As shown in FIG. 5, wirings 93 and a through hole 94 for wiring are formed on the pattern formed surface of the board 9, and the through hole 94 penetrates the board 9, like the auxiliary hole 92. On the board 9, a resist (e.g., solder resist) which is an insulating film is applied to a hatched area in FIG. 5, and the wiring 93 and the background show green slightly different in brightness from each other in the area with resist. The wiring 93 and the background show brown different in brightness from each other in the area without resist (except the auxiliary hole 92 and the through hole 94). On part of the resist, further formed is a character area 95 (referred to also as “silk part”) in which white characters are printed. Though the following discussion will be made assuming that two types of holes are formed on the board 9, in an actual case, various types of holes are formed on the board 9. In the following discussion, the auxiliary hole 92 and the through hole 94 are generally referred to also as “board holes”. The board, the wiring and the resist have various colors, and colors different from those discussed in this preferred embodiment may be used.

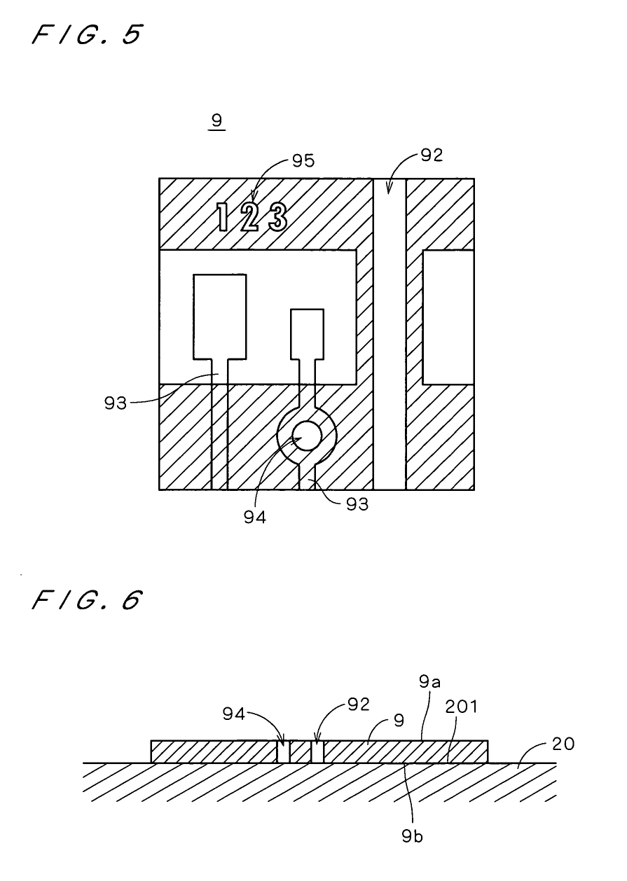

FIG. 6 is a schematic view showing the board 9 placed on the stage part 20. As shown in FIG. 6, opening ends of the auxiliary hole 92 and the through hole 94 on the side of back surface 9b in the board 9 (as discussed above, in an actual case, there are a lot of auxiliary holes 92 and through holes 94 in the board 9) are closed by the stage part 20 to cut off the light entering the auxiliary hole 92 and the through hole 94 from the side of back surface 9b. An opposed surface 201 of the stage part 20 which is in contact with the back surface 9b of the board 9 has a special color, such as purple, pink, yellow or black, which is not among colors present on the pattern formed surface 9a of the board 9. In other words, the opposed surface 201 has such spectral reflectance as to make the spectral intensity of a reflected light thereon different from that of a reflected light on the pattern formed surface 9a with respect to the white illumination light.

When the board 9 is placed on the stage part 20 with its back surface 9b opposed thereto, the light source part 31 emits an illumination light towards the pattern formed surface 9a (Step S12) and the image pickup part 33 receives light from the pattern formed surface 9a to acquire a color inspection image representing the pattern formed surface 9a (Step S13).

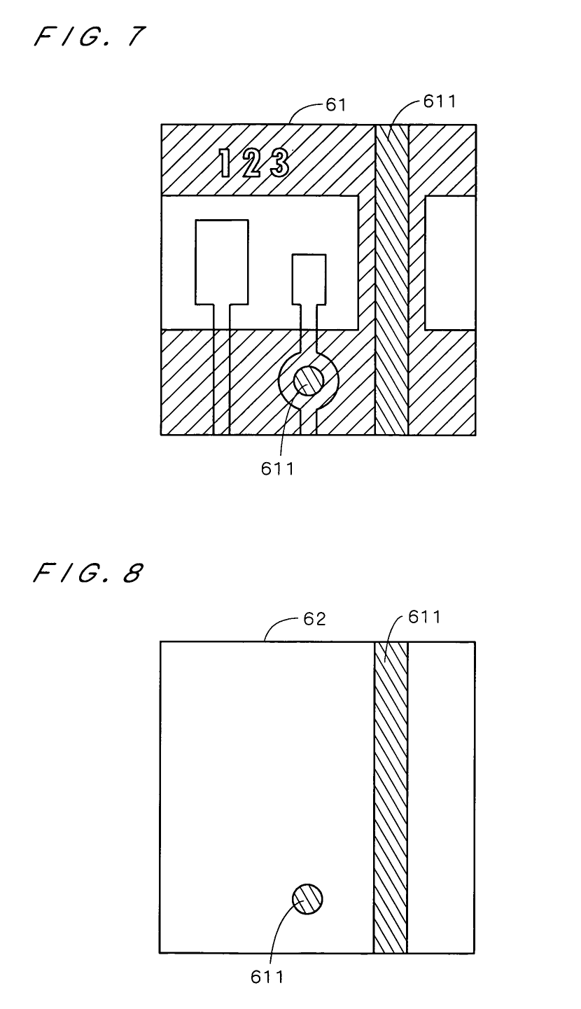

At this time, part of the illumination light from the light source part 31 reaches the opposed surface 201 of the stage part 20 through the board holes and the reflected light from the opposed surface 201 is guided to the image pickup part 33 through the same board holes. Therefore, as shown in FIG. 7, hole areas 611 in the inspection image 61 which correspond to the board holes have a special color which is the color of the opposed surface 201. The other area in the inspection image 61 has the same color as a corresponding area on the pattern formed surface 9a of the board 9. Data of the inspection image 61 is inputted to a hole-area specifying part 51 of the operation part 5 shown in FIG. 2 and the hole area 611 in the inspection image 61 is specified (Step S14).

As an exemplary operation in the hole-area specifying part 51, for example, the method disclosed in Document 4 can be used and the disclosure of which is herein incorporated by reference. Specifically, an operator sets provisional four representative colors (e.g., green, brown, white and special color) in the inspection image 61 through an input part 41 of the computer 4, which represent the area with resist, the area without resist, the character area 95 and the board hole on the board 9, and pixels of the inspection image 61 are arranged in a predetermined color space. The predetermined color space is divided so that each of the pixels should be included in a divided space corresponding to one of a plurality of representative colors which is closest to the pixel. Subsequently, an average value of colors (coordinate values) of all the pixels included in the divided space to which each representative color belongs is determined as a new representative color, and the color space is redivided so that each pixel should be included in a divided space corresponding to one of a plurality of new representative colors which is closest to the pixel. Then, the above operation is repeated, to thereby determine which one of the four areas corresponding to the area with resist, the area without resist, the character area 95 and the board hole on the board 9, each of the pixels in the inspection image 61 belongs to.

Thus, the hole-area specifying part 51 specifies the hole areas 611 in the inspection image 61 which correspond to the board holes by using only the inspection image 61 as image information, in accordance with criteria of pixel values which are affected by a reflection state of the illumination light entering the board hole and being reflected on the stage part 20, and as shown in FIG. 8, a hole-area detection image 62 is generated in which a plurality of hole areas 611 are specified with high accuracy. The hole-area detection image 62 is displayed on the display part 42 of the computer 4 as necessary.

Subsequently, a through-hole specifying part 52 (see FIG. 2) specifies whether the hole area 611 corresponds to the through hole 94 for wiring or not on the basis of the shape or the number of pixels (i.e., area) of the hole area 611 specified by the hole-area specifying part 51 (Step S15). As an exemplary operation in the through-hole specifying part 52, for example, the method disclosed in Document 5 can be used and the disclosure of which is herein incorporated by reference. In this method, a plurality of hole areas 611 included in the hole-area detection image 62 are identified by labels (labeling), respectively, and a plurality of feature values are obtained for each hole area 611. In this case, as the feature values, for example, the length of circumference, the barycenter, the radius, and the aspect ratio, the number of pixels, the circulality or the like may be used, and the feature values include at least something on the basis of the shape or the number of pixels of the hole area 611.

In the through-hole specifying part 52, a plurality of membership functions corresponding to a plurality of feature values, respectively, for each of the auxiliary hole 92 and the through hole 94 are prepared in advance and calculation is performed by inputting a plurality of feature values obtained with respect to each hole area 611 to the membership functions to obtain a plurality of membership values corresponding to a plurality of feature values. Then, on the basis of a plurality of membership values, the adaptation degree of each hole area 611 corresponding to each of the auxiliary hole 92 and the through hole 94 is obtained and the adaptation degrees are compared with one another, to specify which one of the auxiliary hole 92 and the through hole 94 each hole area 611 corresponds to.

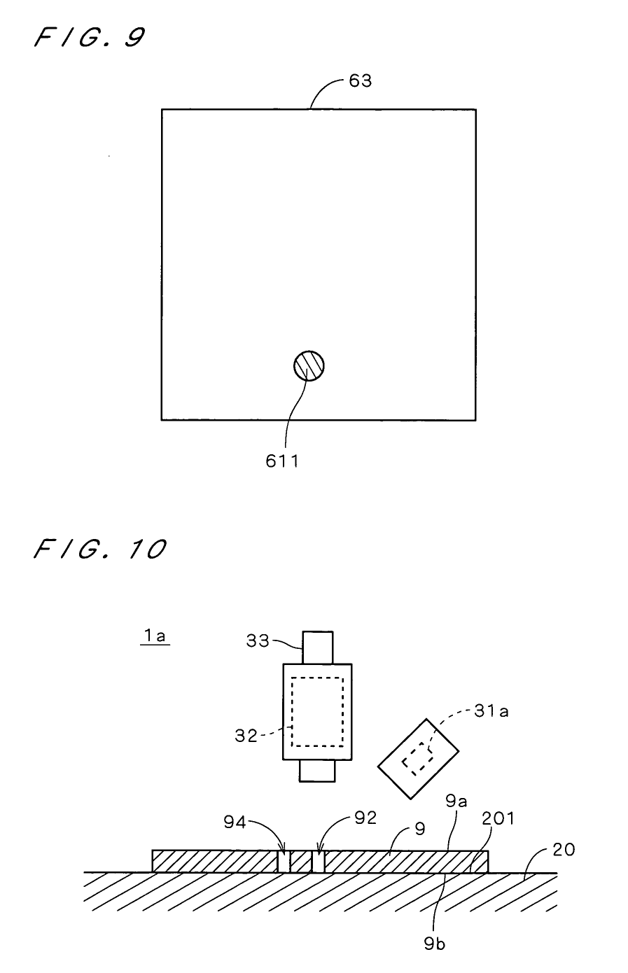

FIG. 9 is a view showing a through-hole detection image 63 representing the detected hole area 611 corresponding to the through hole 94. In the through-hole detection image 63 of FIG. 9, only a circular hole area 611 is detected as one corresponding to the through hole 94. Then, the defect detection part 53 detects a defect of a pattern on the board 9 on the basis of the inspection image 61 in consideration of the hole areas 611 (especially, the hole area 611 corresponding to the through hole 94) and displays the detection result on a display part 42 (Step S16).

Though the white light emitted from the mercury vapor lamp is used as the illumination light in the above discussion, various lamps, such as a fluorescent lamp, a halogen lamp, a xenon lamp, a metal halide lamp, a light emitting diode (LED) (in combination of a plurality of wavelengths), a laser (for example, a white light obtained through crystalline or a mixed solution of water and heavy water), can be used as the light source part 31 and the illumination light emitted from the light source part 31 is not limited to white light but may be light of two colors, e.g., red and green. In this case, the opposed surface 201 of the stage part 20 has such spectral reflectance as to make the spectral intensity of a reflected light thereon different from that of a reflected light on the pattern formed surface 9a with respect to this two-color light, and the image pickup part 33 acquires an inspection image of two colors.

Thus, in the defect detection apparatus 1 of FIG. 1, the light source part 31 for emitting the illumination light of a plurality of wavelengths is provided and the board 9 having board holes is placed on the stage part 20 having a reflection property which is different from that of the pattern formed surface 9a of the board 9 with respect to the illumination light. Then, the image pickup part 33 acquires the multicolor inspection image 61 and the hole areas 611 in the inspection image 61 are specified in accordance with criteria of pixel values affected by the reflection state of the illumination light on the stage part 20.

In recognition of the through hole 94 from the shape of a ring pattern (land portion) around the through hole 94 in the acquired inspection image 61, if the position of the through hole 94 is misregistered (there arises a land break), in some cases, the through hole 94 can not be recognized since the pattern around the through hole 94 does not have a shape of ring. In the defect detection apparatus 1 of FIG. 1, however, the areas of the board holes (the auxiliary hole 92 and the through hole 94) are directly detected by using only the inspection image 61 acquired with the reflected light of the illumination light emitted from the light source part 31, and further the area of the through hole 94 can be appropriately detected on the basis of the shape or the number of pixels of the hole area 611.

Since the boards hole can be detected without providing any transillumination part in the defect detection apparatus 1, it is possible to reduce the cost for manufacturing the apparatus, with size-reduction in construction for detection of the board holes. Further, there may be a case where a plurality of stage parts 20 having respective opposed surfaces 201 of different colors are prepared and the stage part 20 is changed in accordance with the properties of pattern formed on the target board.

As another exemplary operation in the hole-area specifying part 51, for example, the method disclosed in Document 3 can be also used and the disclosure of which is herein incorporated by reference. In this method, an operator sets a plurality of representative colors in the inspection image 61 in advance, which represent the area with resist, the area without resist, the character area 95 and the board hole on the board 9, angle indices in accordance with angles between individual color vectors representing colors of pixels in the inspection image 61 and respective representative color vectors are obtained in the color space. Subsequently, distance indices in accordance with distances between the colors of the pixels in the inspection image 61 and the respective representative colors are obtained in the color space, and composite distance indices with respect to the representative colors based on the angle indices and the distance indices are calculated. Then, it is determined which one of a plurality of areas corresponding to the area with resist, the area without resist, the character area 95 and the board hole, the pixels in the inspection image 61 belong to, and the hole areas 611 are thereby specified.

In the through-hole specifying part 52, the hole areas 611 can be also simply distinguished, for the auxiliary hole 92 or the through hole 94, on the basis of the number of pixels of each of the hole areas 611 in the hole-area detection image 62. In this case, only when it is impossible to distinguish the hole areas 611 by using only their areas, the feature value on the shape is obtained and it is specified whether each of the hole areas 611 corresponds to the through hole 94 for wiring or not.

Next, discussion will be made on the defect detection apparatus 1 in accordance with the second preferred embodiment of the present invention. In the defect detection apparatus 1 of the second preferred embodiment, the opposed surface 201 of the stage part 20 which is in contact with the back surface 9b of the board 9 is a mirror. Other constituent elements are the same as those of the defect detection apparatus 1 of FIG. 1.

In the defect detection apparatus 1 of the second preferred embodiment, in Step S12 of FIG. 3, the illumination light emitted from the light source part 31 enters the board holes penetrating the board 9 and is reflected on the opposed surface 201 of the stage part 20, then the reflected light is guided to the image pickup part 33 through the board holes. Therefore, the pixel values of the hole areas 611 in the inspection image 61 of FIG. 7 which are acquired by the image pickup part 33 have the same hue (color) and brightness (i.e., bright white color) as those of the illumination light from the light source part 31 (Step S13).

The hole-area specifying part 51 specifies the hole areas 611 in the inspection image 61 by using only the inspection image 61 as image information, in accordance with criteria of pixel values affected by in accordance with a reflection state of the illumination light entering the board holes and being reflected on the stage part 20 (Step S14). At this time, since the hole areas 611 in the inspection image 61 has generally white color brighter than the area corresponding to the white character area 95, the hole area 611 can be easily specified. Then, the through-hole specifying part 52 specifies whether each of the hole areas 611 corresponds to the through hole 94 for wiring or not on the basis of at least the shape or the number of pixels of the hole area 611 (Step S15), and the defect detection part 53 detects a defect on the board 9 in consideration of the hole areas 611 (Step S16).

In the defect detection apparatus 1 of the second preferred embodiment, the hole areas in the inspection image can be more easily specified by acquiring a single-color inspection image in the image pickup part 33 and binarizing the inspection image with a predetermined threshold value. The illumination light emitted from the light source part 31 may be light of single wavelength, and in this case, as the opposed surface 201 of the stage part 20 used is one having reflectance higher than that of the pattern formed surface 9a with respect to the light of single wavelength.

Thus, in the defect detection apparatus 1 of the second preferred embodiment, as the opposed surface 201 of the stage part 20 used is one having reflectance higher than that of the pattern formed surface 9a with respect to the illumination light from the light source part 31. This allows easy and direct detection of the area of the board hole on the board 9, by using only the inspection image acquired with the reflected light of the illumination light from the light source part 31, without using any reference image derived from. e.g., design data or the board having no defect, and it is therefore possible to achieve appropriate detection of a defect on the board 9. Ideally, the opposed surface 201 of the stage part 20 has reflectance higher than that of any area on the pattern formed surface 9a with respect to the illumination light from the light source part 31.

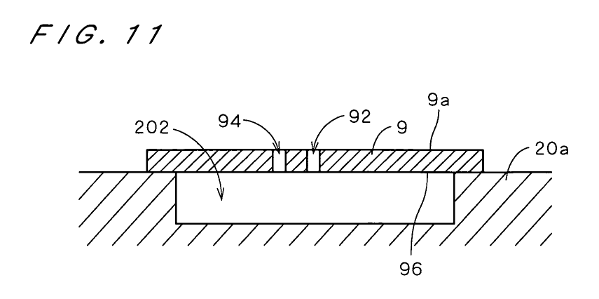

Next, discussion will be made on another exemplary defect detection apparatus in accordance with the second preferred embodiment. FIG. 10 is a view showing part of another exemplary defect detection apparatus 1a in accordance with the second preferred embodiment. In the defect detection apparatus 1a of FIG. 10, a light source part 31a is provided independently from the optical system 32 and the image pickup part 33, being inclined, above the stage part 20. Therefore, an oblique illumination is made by the light source part 31a, in which the illumination light is emitted onto the pattern formed surface 9a of the board 9 from an inclined direction. The opposed surface 201 of the stage part 20 in FIG. 10 is also a mirror.

In the defect detection apparatus 1a of FIG. 10, since the illumination light from the light source part 31a, entering the auxiliary hole 92 and the through hole 94, is reflected on the opposed surface 201 in a direction different from that of the optical system 32 and the image pickup part 33, the hole areas 611 in the inspection image 61 of FIG. 7 which is acquired by the image pickup part 33 are black. Though part of the illumination light is diffusedly reflected on the inside surfaces of the auxiliary hole 92 and the through hole 94, however, an influence on the inspection image 61 is almost nothing. Since the hole-area specifying part 51 thereby specifies the black areas on the basis of the inspection image 61, the hole areas 611 in the inspection image 61 can be easily specified to detect the areas of the auxiliary hole 92 and the through hole 94 on the board 9. Since the wiring 93 on the board 9 generally has a rough surface, it is possible to detect an area in the inspection image 61 which corresponds to the wiring 93 even in the case of oblique illumination.

FIG. 11 is a view showing a stage part 20a of a defect detection apparatus in accordance with the third preferred embodiment. In the stage part 20a of the third preferred embodiment, a recessed portion 202 is provided on a side opposed the board 9, and side surfaces and a bottom surface (in other words, inside surfaces) of the recessed portion 202 are black. Other constituent elements are the same as those of the defect detection apparatus 1 of FIG. 1.

In the defect detection apparatus of FIG. 11, the illumination light from the light source part 31 which enters the auxiliary hole 92 and the through hole 94 is guided into the recessed portion 202 and absorbed inside the recessed portion 202. Therefore, the hole areas 611 in the inspection image 61 o FIG. 7 acquired by image pickup part 33 are black, in other words, have pixel values of low brightness. The hole-area specifying part 51 specifies the black areas in the inspection image 61, to acquire the hole areas 611 in the inspection image 61, and detects the areas of the board holes. Then, whether the hole area 611 corresponds to the through hole 94 for wiring or not is specified on the basis of at least the shape or the number of pixels.

Thus, in the defect detection apparatus of the third preferred embodiment, the illumination light from the light source part 31 which enters the hole penetrating the board 9 is absorbed by the stage part 20a. It is thereby possible to easily specify the hole areas 611 in the inspection image 61 by using only the inspection image 61 as image information, in accordance with criteria of pixel values affected by an absorption state (in other words, a reflection state) of the illumination light in the stage part 20a and detect the areas of the board holes. In the stage part 20a of FIG. 11, it is not always necessary to provide the recessed portion 202 but for example, there may be a case of adhering a black cloth having a reflection property different from that of the pattern formed surface 9a of the board 9 to the opposed surface of the stage part 20a. In other words, the stage part 20a may have any structure only if this can absorb the illumination light from the light source part 31 more than the pattern formed surface 9a (ideally, any area on the pattern formed surface 9a) of the board 9.

In the defect detection apparatus of FIG. 11, the hole area in the inspection image can be specified by acquiring a single-color inspection image in the image pickup part 33 and binarizing the inspection image with a predetermined threshold value. The illumination light emitted from the light source part 31 may be light of single wavelength (monochromatic light).

Though the preferred embodiments of the present invention have been discussed above, the present invention is not limited to the above-discussed preferred embodiments, but allows various variations.

In the above preferred embodiments, there may be a case where the inspection image 61 acquired by the image pickup part 33 is stored in an external storage unit and another computer having functions of the hole-area specifying part 51 and the through-hole specifying part 52 reads the inspection image 61 out from the storage unit, to detect an area of a hole on the board 9.

The image pickup part 33 does not necessarily have the two-dimensional array of photodetectors but may be, e.g., a line sensor having one-dimensional array of photodetectors and in this case, the image pickup part 33 may acquire a two-dimensional inspection image in synchronization with the stage driving part 21.

Also in the defect detection apparatus of the first and third preferred embodiments, like in the defect detection apparatus 1a of FIG. 10, the oblique illumination may be performed.

In the above preferred embodiments, a function serving as a hole-area detection apparatus, which is implemented by the light source part 31 or 31a, the stage part 20 or 20a, the image pickup part 33, the hole-area specifying part 51 and the through-hole specifying part 52, is not necessarily used for defect detection, but may be used for other purposes, such as detection of a board hole in a substrate processing apparatus. A printed circuit board on which through holes 94 for wiring are formed is most suitable as an object for detection of a hole by the hole-area detection apparatus, but any plate-like member in which a hole penetrating the member is formed may be used as the object.

While the invention has been shown and described in detail, the foregoing description is in all aspects illustrative and not restrictive. It is therefore understood that numerous modifications and variations can be devised without departing from the scope of the invention.

This application claims priority benefit under 35 U.S.C. Section 119 of Japanese Patent Application No. 2004-143798 filed in the Japan Patent Office on May 13, 2004, the entire disclosure of which is incorporated herein by reference.

1. An apparatus for detecting an area of a hole penetrating a board, comprising:
a light source part for emitting an illumination light onto one main surface of a board;
an opposed member provided, being opposed to the other main surface of said board, to cut off light entering a hole penetrating said board from a side of said other main surface, having a reflection property which is different from that of said one main surface with respect to said illumination light;
an image pickup part receiving light from said one main surface onto which said illumination light is emitted to acquire an image representing said one main surface; and
a hole-area specifying part for specifying a hole area in said image, which corresponds to a hole penetrating said board, by using only said image as image information, in accordance with criteria of pixel values affected by a reflection state of said illumination light entering a hole penetrating said board and being reflected on said opposed member.

2. The apparatus according to claim 1, wherein
said light source part emits an illumination light of a plurality of wavelengths and said image pickup part acquires a multicolor image, and
said opposed member comprises an opposed surface being in contact with said other main surface, having such spectral reflectance as to make spectral intensity of a reflected light thereon different from that of a reflected light on said one main surface with respect to said illumination light.

3. The apparatus according to claim 1, wherein
said opposed member comprises an opposed surface being in contact with said other main surface, having reflectance which is higher than that of said one main surface with respect to said illumination light.

4. The apparatus according to claim 3, wherein
said opposed surface is a mirror.

5. The apparatus according to claim 4, wherein
said illumination light is emitted onto said board from a direction almost orthogonal to said board.

6. The apparatus according to claim 4, wherein
said illumination light is emitted onto said board from a direction inclined with respect to said board.

7. The apparatus according to claim 1, wherein
said opposed member absorbs said illumination light more than said one main surface.

8. The apparatus according to claim 7, wherein
said opposed member comprises a recessed portion opposed to said board, having an inside surface of black.

9. The apparatus according to claim 1, wherein
said board is a printed circuit board on which a through hole for wiring is formed.

10. The apparatus according to claim 9, further comprising
a through-hole specifying part for specifying whether said hole area specified by said hole-area specifying part corresponds to said through hole for wiring or not, on the basis of shape or number of pixels of said hole area.

11. A method of detecting an area of a hole penetrating a board, comprising the steps of:
arranging a board on an opposed member having a reflection property which is different from that of one main surface of said board with respect to an illumination light so that the other main surface of said board is opposed to said opposed member, said opposed member cutting off light entering a hole penetrating said board from a side of said other main surface;
emitting said illumination light from a light source part towards said one main surface;
receiving light from said one main surface onto which said illumination light is emitted to acquire an image representing said one main surface by an image pickup part; and
specifying a hole area in said image, which corresponds to a hole penetrating said board, by using only said image as image information, in accordance with criteria of pixel values affected by a reflection state of said illumination light entering a hole penetrating said board and being reflected on said opposed member.

12. The method according to claim 11, wherein
said light source part emits an illumination light of a plurality of wavelengths and said image pickup part acquires a multicolor image, and
said opposed member comprises an opposed surface being in contact with said other main surface, having such spectral reflectance as to make spectral intensity of a reflected light thereon different from that of a reflected light on said one main surface with respect to said illumination light.

13. The method according to claim 11, wherein
said opposed member comprises an opposed surface being in contact with said other main surface, having reflectance which is higher than that of said one main surface with respect to said illumination light.

14. The method according to claim 13, wherein
said opposed surface is a mirror.

15. The method according to claim 14, wherein
said illumination light is emitted onto said board from a direction almost orthogonal to said board.

16. The method according to claim 14, wherein
said illumination light is emitted onto said board from a direction inclined with respect to said board.

17. The method according to claim 11, wherein
said opposed member absorbs said illumination light more than said one main surface.

18. The method according to claim 17, wherein
said opposed member comprises a recessed portion opposed to said board, having an inside surface of black.

19. The method according to claim 11, wherein
said board is a printed circuit board on which a through hole for wiring is formed.

20. The method according to claim 19, further comprising
a through-hole specifying part for specifying whether said hole area specified in said step of specifying said hole area corresponds to said through hole for wiring or not, on the basis of shape or number of pixels of said hole area.
